(19) United States
(12) Patent Application Publication
(10) Pub. No.: US 2007/0171346 A1
(43) Pub. Date: Jul. 26, 2007

(54) Mold frame, backlight unit and liquid crystal display having the same

(75) Inventors: Se In Chang, Suwon-Si (KR); Hwan Jin Kim, Seongnam-Si (KR)

Correspondence Address: F. Chau & Associates, LLC, 130 Woodbury Road, Woodbury, NY, 11797, US

(73) Assignee: Samsung Electronics Co., Ltd., Suwon-si (KR)

(21) Appl. No.: 11/645,976

(22) Filed: Dec. 27, 2006

(30) Foreign Application Priority Data
Jan. 25, 2006 (KR) 10-2006-0007958

(51) Int. Cl. G02F 1/1345; G02F 1/1333

(52) U.S. Cl. 349/150; 349/58

(57) ABSTRACT

An LCD including a mold frame including a plurality of sidewalls and at least one support extending from at least one of the plurality of sidewalls into a storage space defined therein by the plurality of sidewalls, an LCD panel disposed in the storage space of the mold frame, a flexible printed circuit board including a circuit for driving the LCD panel electrically connected to the LCD panel, at least one fixing member formed on a first sidewall of the plurality of sidewalls of the mold frame to protrude from the first sidewall into the storage space and to thereby fix the LCD panel, a light guiding plate positioned in the storage space of the mold frame, and a light source positioned at one side of the light guiding plate. The flexible printed circuit board is bent along the first sidewall of the mold frame and the fixing members are formed on the first sidewall.

### CROSS-REFERENCE TO RELATED APPLICATION

This application claims priority to Korean Patent Application No. 10-10-2006-0007958, filed on Jan. 25, 2006, in the Korean Intellectual Property Office, the disclosure of which is herein incorporated by reference in its entirety.

### BACKGROUND OF THE INVENTION

1. Field of the Invention

The present invention relates to a mold frame, a backlight unit and a liquid crystal display having the same. More particularly, the present invention relates to a mold frame formed with a structure capable of substantially preventing a liquid crystal display panel from separating from the mold frame.

2. Description of Related Art

A liquid crystal display (LCD) adjusts an amount of light transmitted in accordance with image signals applied to a number of control switches arrayed in a matrix form and thereby displays a desired image on an LCD panel. The LCD comprises an LCD panel for displaying images, an LCD drive IC (integrated circuit) for operating the LCD panel, a backlight unit used as a light source of the LCD, and a chassis used to fasten respective components of the LCD into a single unit.

Typically, an LCD is configured in such a manner that an LCD panel is fixed to a mold frame by means of an adhesive tape attached on the mold frame for accommodating the LCD panel.

In a case where the LCD panel is fixed by the adhesive tape, the LCD panel may separate from the adhesive tape when a force greater than the adhesive strength of the adhesive tape is applied, e.g., when a bending tension is applied a flexible printed circuit board connected to the LCD panel. Accordingly, the LCD panel may separate from the mold frame.

Therefore, a need exists for an apparatus for substantially preventing the LCD panel from separating from the mold frame under a bending tension applied by a flexible circuit board.

### SUMMARY OF THE INVENTION

According to an embodiment of the present invention, a liquid crystal display (LCD) comprises a mold frame including a plurality of sidewalls and at least one support extending from at least one of the plurality of sidewalls into a predetermined storage space defined therein by the plurality of sidewalls, an LCD panel disposed in the storage space of the mold frame, a flexible printed circuit board comprising a circuit for driving the LCD panel electrically connected to the LCD panel, at least one fixing member formed on a first sidewall of the plurality of sidewalls of the mold frame to protrude from the first sidewall into the storage space and to thereby fix the LCD panel, a light guiding plate positioned in the storage space of the mold frame, and a light source positioned at one side of the light guiding plate, wherein the flexible printed circuit board is bent along the first sidewall of the mold frame and the fixing members are formed on the first sidewall.

The LCD panel is disposed between the at least one fixing member and the at least one support of the mold frame.

The light source includes at least one light emitting diode.

In addition, the LCD may further comprise a plurality of optical sheets positioned above the light guiding plate, a reflection plate positioned below the light guiding plate, and a chassis coupled with the mold frame.

The at least one fixing member substantially prevents the LCD panel from moving in a direction out of the storage space of the mold frame under a bending tension applied by the flexible printed circuit. The at least one fixing member may be formed only on the first sidewall.

According to an embodiment of the present invention, a mold frame for a display device comprises a plurality of sidewalls defining a storage space therein, at least one support extending from at least one of the plurality of sidewalls into the storage space, and at least one fixing member formed on a first sidewall of the plurality of sidewalls to protrude from the first sidewall into the storage space, the fixing member comprising a protrusion having a grove for receiving and substantially fixing an LCD panel from moving in a direction out of the storage space.

The LCD panel is disposed between the least one fixing member and the at least one support.

The mold frame further comprises a chassis coupled with the mold frame.

The at least one fixing member substantially prevents the LCD panel from moving in the direction out of the storage space of the mold frame under a bending tension applied by a flexible printed circuit coupled to the LCD panel and bent along the first sidewall of the mold frame. The at least one fixing member may be formed only on the first sidewall.

### BRIEF DESCRIPTION OF THE DRAWINGS

The present invention will become apparent from the following description of preferred embodiments given in conjunction with the accompanying drawings, in which:

FIGS. 1A and 1B are plan and sectional views of a liquid crystal display (LCD) according to a first embodiment of the present invention, respectively;

FIGS. 2A and 2B are enlarged views showing circled portions of the LCD shown in FIGS. 1A and 1B, respectively;

FIG. 3 is an enlarged partial perspective view of the LCD shown in FIGS. 1A and 1B;

FIG. 4 is a plan view of an LCD according to an embodiment of the present invention;

FIGS. 5A and 5B are plan views of LCDs according to embodiments of the present invention; and

FIG. 6 is an exploded perspective view of the LCD according to the present invention.

### DETAILED DESCRIPTION OF PREFERRED EMBODIMENTS

Hereinafter, preferred embodiments of the present invention will be described in detail with reference to the accompanying drawings.

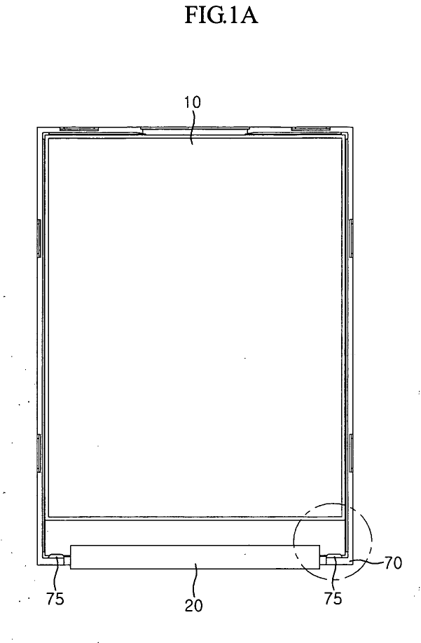

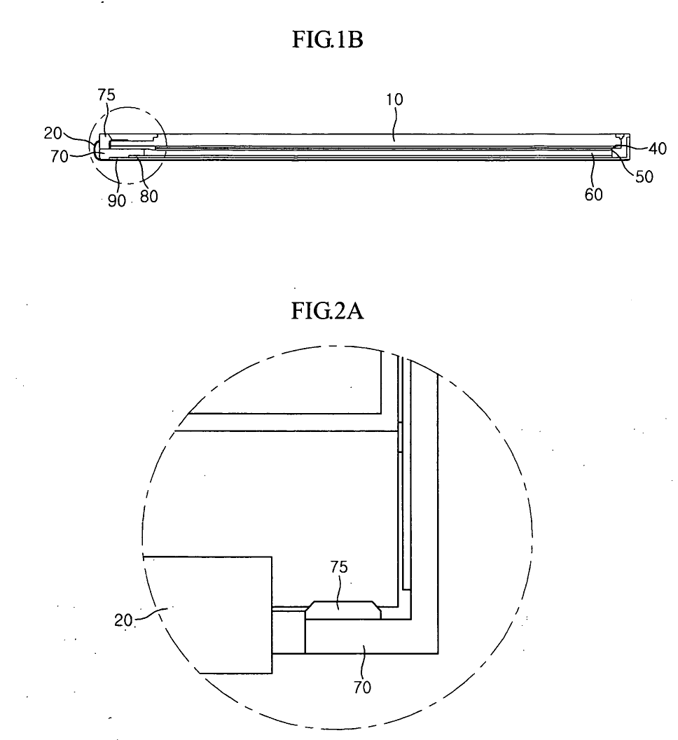

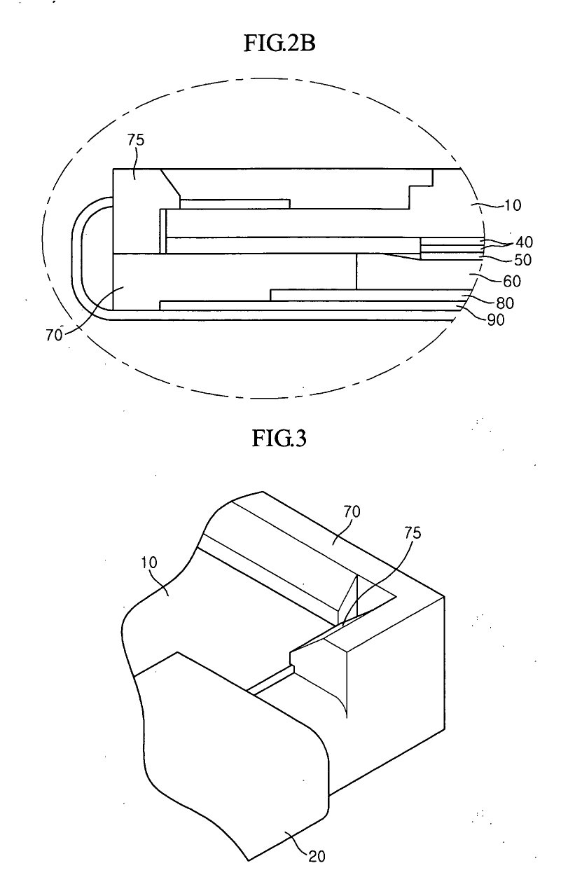

FIGS. 1A and 1B are plan and sectional views of a liquid crystal display (LCD) according to an embodiment of the present invention, respectively; FIGS. 2A and 2B are enlarged views showing circled portions of the LCD shown in FIGS. 1A and 1B, respectively; and FIG. 3 is an enlarged partial perspective view of circled portions of the LCD shown in FIGS. 1A and 1B.

Referring to FIGS. 1A to 3, the LCD comprises an LCD panel 10, an LCD drive IC (not shown), a flexible printed circuit board 20, a light source (not shown), a plurality of prism sheets 40, a diffusion plate 50, a light guiding plate 60, a mold frame 70, fixing members 75, a reflection plate 80 and a chassis 90.

The LCD panel 10 comprises a color filter substrate, a thin film transistor (TFT) substrate, and a liquid crystal layer injected into a space between the color filter substrate and the TFT substrate. The color filter substrate is formed with an RGB color filter from which a predetermined color is produced while light passes through the pixel. The color filter substrate comprises a black matrix, the RGB color filter and an overcoat film. Further, a common electrode made of a transparent conductor such as indium tin oxide (ITO) or indium zinc oxide (IZO) is disposed on a front surface of the overcoat film.

The TFT substrate is a transparent glass substrate on which TFTs are arrayed in a matrix form. Data lines are connected to source terminals of the TFTs. Gate lines are connected to gate terminals of the TFTs. Further, pixel electrodes, each of which serves as a transparent electrode made of a transparent conductive material, are formed at drain terminals. Electric signals input to the data and gate lines turn respective TFTs on or off. If an electric signal is applied to the gate and source terminals of the TFT substrate to turn on a TFT, an electric field is created between the common electrodes of the color filter substrate and the pixel electrodes. The electric field changes the alignment of liquid crystal injected between the TFT substrate and the color filter substrate and the light transmittance is also changed in accordance with the changed alignment, to display desired images.

The LCD drive IC is connected to the LCD panel 10, and predetermined gate and data signals are applied to the gate and data lines of the TFT substrate, respectively.

The flexible printed circuit board 20 is electrically connected to the LCD panel 10 and the LCD drive IC. Further, a variety of circuit components, e.g., a timing controller which generates electric signals for controlling gate and source driver ICs and controls digital data signals inputted from a computer or the like, a DC-DC converter circuit for generating different kinds of voltage, a gamma standard voltage generator for outputting a gray scale voltage of a source driver IC, and the like, may be electrically coupled to the flexible printed circuit board 20.

A plurality of light emitting diodes (LEDs) may be used as a light source. Such LEDs are mounted on an LED flexible printed circuit board (not shown) and arranged at one side of the light guiding plate 60. The light guiding plate 60 functions to convert light emitted from the LEDs into light having substantially the same optical distribution as that of a surface light source. A variety of light guiding plates such as a wedge type plate and a parallel flat plate may be used as the light guiding plate 60.

Preferably, a plate with high light reflectivity is used as the reflection plate 80 and installed to come into contact with a bottom surface of the chassis 90. Although the reflection plate 80 has been illustrated to have a flat shape, it may be manufactured into a bent shape which has a reference reflection surface and a triangle protruding from the reference reflection surface. Further, if a material with high reflection efficiency is formed on the bottom surface of the chassis 90, the reflection plate 80 may be omitted.

The diffusion plate 50 and the plurality of prism sheets 40 are sequentially positioned on a top surface of the light guiding plate 60. Light passing through the top surface of the light guiding plate 60 includes light emitted normally and at various angles from the top surface thereof. The diffusion plate 50 scatters light incident thereon from the light guiding plate 60 to prevent the light from being partially collected. Further, the plurality of prism sheets 40 may include first and second prism sheets, each of which is formed with a certain arrangement of triangular prisms on a top surface thereof positioned to cross each other, to condense or collect light diffused from the diffusion plate 50 in a direction normal to a plane of the LCD panel 10. Although it has been described that the prism sheets 40 include multiple prism sheets, the present invention is not limited thereto. That is, a single prism sheet may be used for condensing or collecting light.

A predetermined storage space is formed within the mold frame 70. The light source, the light guiding plate 60, the diffusion plate 50, the plurality of prism sheets 40 and the reflection plate 80 are accommodated in the storage space of the mold frame 70.

The mold frame 70 is shaped substantially as a rectangular frame with an open center and comprises a plurality of sidewalls (preferably, four sidewalls) and a plurality of supports extending inward from the sidewalls. The plurality of supports extend in a direction perpendicular to the sidewalls and parallel with the plane of the LCD panel 10. The LCD panel 10 is positioned on the plurality of supports.

The fixing members 75 are formed on inner surfaces of at least one of the plurality of sidewalls. The fixing members 75 are formed to protrude from the inner surfaces of the sidewalls in a direction in which the storage space is formed, an inward direction of the mold frame 70.

The flexible printed circuit board 20 is connected to one side of the LCD panel 10, bent along the sidewall of the mold frame 70 and attached to the bottom surface of the chassis 90. A bending tension generated when the flexible printed circuit board 20 is bent may cause the LCD panel 10 to be moved upward, separating a portion of the LCD panel from the mold frame 70. Preferably, the fixing members 75 are formed on the sidewall of the mold frame 70 facing a portion where the flexible printed circuit board 20 is bent and a fixing member 75 is formed at each of the left and right sides of the flexible printed circuit board 20. Further, the fixing members 75 are preferably integrally formed with the mold frame 70 and may be shaped as a rectangle as viewed in a plan view of the LCD. The number and shape of the fixing members 75 are not limited thereto but may be variously modified. For example, the fixing members 75 may be formed separately from the mold frame 70 and/or may be formed as semi-circles, triangles, etc.

The LCD panel 10 is disposed between the supports and the fixing members 75 formed on the inner surface of the sidewall. The fixing members 75 substantially prevent the bending tension applied when the flexible printed circuit board 20 is bent to one side of the LCD panel from moving the LCD panel 10 in a vertical direction. Accordingly, it is possible to substantially prevent the LCD panel 10 from separating from the mold frame 70.

The chassis 90 is installed beneath the bottom surface of the mold frame 70 and is coupled with the mold frame 70 such that all components of the LCD can be fastened to the chassis 90.

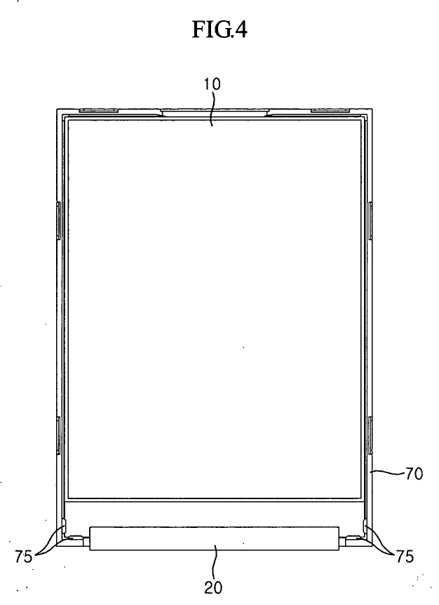

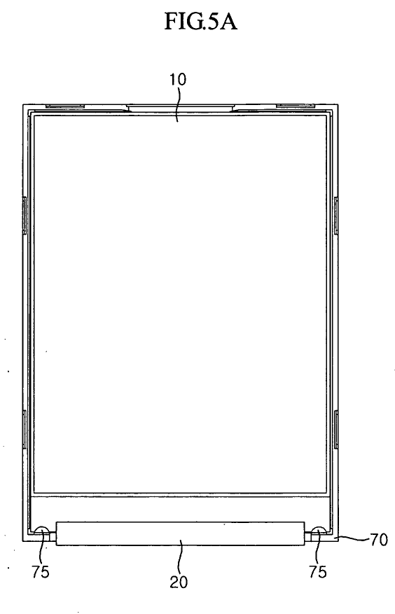

FIG. 4 is a plan view of an LCD according to an embodiment of the present invention.

Referring to FIG. 4, the LCD comprises fixing members formed on inner surfaces of a plurality of sidewalls of a mold frame. Other components are substantially identical to those described with reference to FIGS. 1A to 3.

The LCD comprises an LCD panel 10, a flexible printed circuit board 20, a mold frame 70 and fixing members 75.

A storage space is formed within the mold frame 70. A light source, a light guiding plate, a diffusion plate, a plurality of prism sheets and the reflection plate are accommodated in the storage space of the mold frame 70.

The mold frame 70 is shaped substantially as a rectangular frame with an open center and comprises a plurality of sidewalls (preferably, four sidewalls) and a plurality of supports extending inward from the sidewalls. The plurality of supports extend in a direction perpendicular to the sidewalls, e.g., a direction parallel with the plane of the LCD panel 10. Further, the LCD panel 10 is disposed on the plurality of supports.

The fixing members 75 are formed on inner surfaces of the three sidewalls among the four sidewalls. The fixing members 75 protrude from the inner surfaces of the sidewalls in a direction in which the storage space is formed, e.g., an inward direction of the mold frame 70.

The flexible printed circuit board 20 is connected to one side of the LCD panel 10 and bent along the sidewall of the mold frame 70 and attached to the bottom surface of the chassis 90. A pair of the fixing members 75 are formed on the sidewall of the mold frame 70 facing a portion where the flexible printed circuit board 20 is bent, and an additional fixing member is formed on each of sidewalls adjacent to the facing sidewall. It is preferred that the fixing member 75 be integrally formed with the mold frame 70, and the fixing member 75 may be shaped as a rectangle as viewed in a plan view of the LCD. The number and shape of the fixing members 75 are not limited thereto but may be variously modified. For example, the fixing members 75 may be formed separately from the mold frame 70.

Since the plurality of fixing members 75 are formed on the three sidewalls of the mold frame 70 in the LCD, the up and down movement of the LCD panel 10 is further limited such that the LCD panel 10 can be substantially prevented from being separated from the mold frame 70.

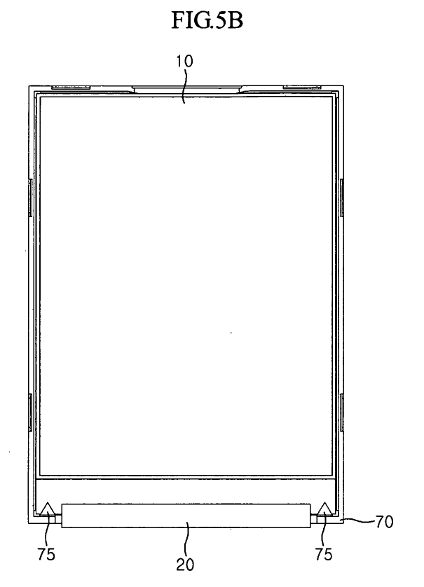

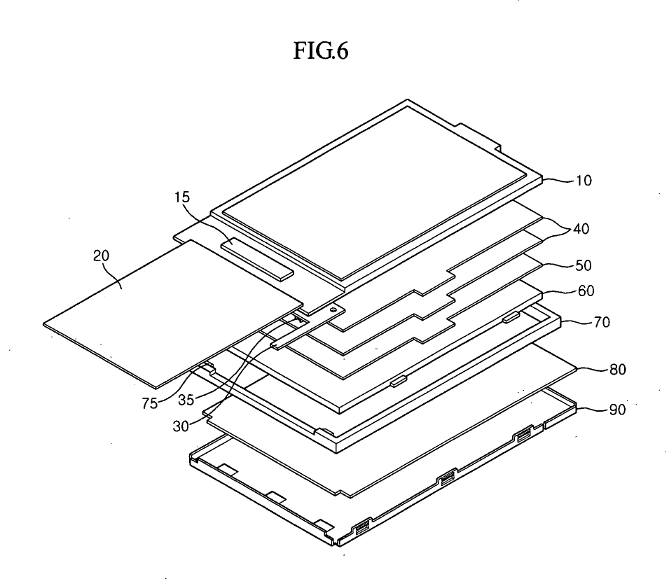

FIGS. 5A and 5B are plan views of LCDs according to embodiments of the present invention, respectively.

Referring to FIGS. 5A and 5B, the LCD includes fixing members having shapes other than rectangles formed on the inner surfaces of the sidewalls of the mold frame. Other components of FIGS. 5A and 5B are substantially similar to those of FIGS. 1A to 4. Each of the LCDs of FIGS. 5A and 5B comprises an LCD panel 10, a flexible printed circuit board 20, a mold frame 70 and fixing members 75.

The fixing members 75 are formed on any one of a plurality of sidewalls of the mold frame 70. The fixing members 75 are formed to protrude from the inner surface of the sidewall toward a direction in which the storage space is formed, e.g., an inward direction of the mold frame 70. The fixing members 75 are shaped into a semicircle as shown in FIG. 5A and a triangle as shown in FIG. 5B, respectively, as viewed in a plan view of the LCD. Furthermore, the fixing members 75 may be formed on a plurality of sidewalls as discussed with reference to FIGS. 1A to 4.

FIG. 6 is an exploded perspective view of an LCD according to an embodiment of the present invention.

Referring to FIG. 6, the LCD comprises an LCD panel 10, an LCD drive IC 15, a flexible printed circuit board 20, an LED flexible printed circuit board 30, LEDs 35, a plurality of prism sheets 40, a diffusion plate 50, a light guiding plate 60, a mold frame 70, fixing members 75, a reflection plate 80 and a chassis 90.

The LCD panel 10 comprises a color filter substrate, a TFT substrate and a liquid crystal layer. Further, the LCD drive IC 15 is mounted on the LCD panel 10 such that gate and data signals can be applied to gate and data lines of the TFT substrate, respectively. The LEDs 35 mounted on the LED flexible printed circuit board 30 are disposed at one side of the light guiding plate 60 on which the plurality of prism sheets 40 and the diffusion plate 50 in turn are sequentially positioned on a top surface of the light guiding plate 60, so that the luminance distribution of light emitted from the light guiding plate 60 can be substantially uniform. A plate with high light reflectivity is used as the reflection plate 80 and installed to come into contact with a bottom surface of the chassis 90.

The fixing members 75 formed on an inner surface a sidewall of the mold frame 70 are positioned above the LCD panel 10, and substantially prevent the LCD panel 10 from being moved in a up and down direction by even though a bending tension generated when the flexible printed circuit board 20 is bent is applied to one side of the LCD panel. Accordingly, it is possible to substantially prevent the LCD panel 10 from being disconnected from the flexible printed circuit board 20.

Although the present invention has been described in detail in connection with preferred embodiments, it will be readily understood by those skilled in the art that various modifications and changes can be made thereto within the technical spirit and scope of the present invention. It is also apparent that the modifications and changes fall within the scope of the present invention.

What is claimed is:

1. A liquid crystal display (LCD), comprising:
a mold frame including a plurality of sidewalls and at least one support extending from at least one of the plurality of sidewalls into a storage space defined therein by the plurality of sidewalls;
an LCD panel disposed in the storage space of the mold frame;
a flexible printed circuit board comprising a circuit for driving the LCD panel electrically connected to the LCD panel;
at least one fixing member formed on a first sidewall of the plurality of sidewalls of the mold frame to protrude from the first sidewall into the storage space and to thereby fix the LCD panel;
a light guiding plate positioned in the storage space of the mold frame; and
a light source positioned at one side of the light guiding plate,
wherein the flexible printed circuit board is bent along the first sidewall of the mold frame and the fixing members are formed on the first sidewall.

2. The LCD as claimed in claim 1, wherein the LCD panel is disposed between the at least one fixing member and the at least one support of the mold frame.

3. The LCD as claimed in claim 1, wherein the light source includes at least one light emitting diode.

4. The LCD as claimed in claim 1, further comprising:
a plurality of optical sheets positioned above the light guiding plate;
a reflection plate positioned below the light guiding plate; and
a chassis coupled with the mold frame.

5. The LCD as claimed in claim 1, wherein the at least one fixing member substantially prevents the LCD panel from moving in a direction out of the storage space of the mold frame under a bending tension applied by the flexible printed circuit.

6. The LCD as claimed in claim 1, wherein the at least one fixing member is formed only on the first sidewall.
